(19) United States
(12) Patent Application Publication
(10) Pub. No.: US 2013/0057168 A1
(43) Pub. Date: Mar. 7, 2013

(54) Lighting Systems

(71) Applicant: David Thomas Summerland, Leicestershire (GB)

(72) Inventor: David Thomas Summerland, Leicestershire (GB)

(73) Assignee: HOLDIP Limited, Douglas (GB)

(21) Appl. No.: 13/375,376

(22) PCT Filed: Jun. 1, 2010
(86) PCT No.: PCT/GB10/50919

§ 371 Date: Nov. 30, 2011

(30) Foreign Application Priority Data
Jun. 1, 2009 (GB) 0909302.2
Jan. 26, 2010 (GB) 1001220.1

(51) Int. Cl. H05B 37/00

(52) U.S. Cl. 315/200 R; 315/291; 315/246

(57) ABSTRACT

A power adaptor for a solid state light source is disclosed. The power adaptor comprises an input (10) for connection to a mains power supply, a drive circuit (60) for providing an output suitable for driving the solid state light source, and a discharge circuit (50) adapted to drain power by providing a discharge current path. The discharge circuit (50) is adapted to be active during at least a portion of the period in which the drive circuit (60) is inactive, and the discharge circuit (50) is adapted to be inactive during at least a portion of the period in which the drive circuit (60) is active.

This invention relates to lighting systems, and in particular to power adaptors for solid state light sources.

Recently, solid state light sources, such as light emitting diodes (LEDs), have been incorporated into conventional lighting systems, particularly those found in domestic settings. LEDs are current-driven devices whose brightness is substantially proportional to their forward current. Conventionally, therefore, a solid state light source would be driven by a power adaptor that regulates the current through the light source.

An AC phase dimmer typically includes a TRIAC activated by a passive phase shift circuit. Because of switching transients, which would otherwise cause serious EMI problems, the TRIAC is bypassed by a capacitor and has an inductor in series with its output.

The input of a typical inactive LED driver is high impedance, with a capacitor on the DC side of the bridge rectifier. The capacitor across the triac allows a small current to flow through the bridge rectifier and the smoothing capacitor starts to charge. When the voltage builds up, the LED driver will try to operate. The result is an occasional flicker of the LED.

What is generally required is a discharge circuit, to keep the smoothing capacitor voltage below that required to start the LED driver. Conventional discharge circuits utilise a load resistor connected to the AC input, for maintaining the voltage of the smoothing capacitor voltage below the activation voltage of the LED driver. To prevent high power loss when the circuit is active, conventional discharge circuits utilise a voltage detector to disconnect the load resistor when a voltage above a pre-determined maximum limit is detected.

However, conventional LED drivers adapted to be powered by an AC phase dimmer are not entirely satisfactory. In particular, prior art circuits often have a significantly reduced efficiency, relative to circuits that are not adapted for use with AC phase dimmers.

There has now been devised an improved power adaptor which overcomes or substantially mitigates the above-mentioned and/or other disadvantages associated with the prior art.

According to the invention, there is provided a power adaptor for a solid state light source, the power adaptor comprising an input for connection to a mains power supply, a drive circuit for providing an output suitable for driving the solid state light source, and a discharge circuit adapted to drain power by providing a discharge current path, wherein the discharge circuit is adapted to be active during at least a portion of the period in which the drive circuit is inactive cycle, and the discharge circuit is adapted to be inactive during at least a portion of the period in which the drive circuit is active.

The power adaptor according to the invention is advantageous principally because the discharge circuit may be adapted to drain power only when the drive circuit is inactive. Most preferably, the discharge circuit is adapted to be active during at least a portion of the period in which the drive circuit is inactive in each mains cycle, and the discharge circuit is adapted to be inactive during at least a portion of the period in which the drive circuit is active in each mains cycle.

The efficiency of the power adaptor is therefore significantly improved relative to prior art arrangements, which rely on monitoring the voltage at the input of the power adaptor to deactivate the discharge circuit. Indeed, according to a further aspect of the invention, there is provided a power adaptor for a solid state light source, the power adaptor comprising an input for connection to a mains power supply, a drive circuit for providing an output suitable for driving the solid state light source, and a discharge circuit adapted to drain power by providing a discharge current path, wherein deactivation of the discharge circuit is controlled without monitoring the voltage at the input of the power adaptor.

The power adaptor preferably includes an auxiliary power supply that provides reduced voltage power to the drive circuit. In these embodiments, the discharge circuit is preferably adapted to drain power when the output of the auxiliary power supply is greater than a pre-determined level. Most preferably, this pre-determined level is less than the level at which the drive circuit is activated.

The discharge circuit is preferably adapted to drain power when the output of the auxiliary power supply is greater than an activation level that is greater than zero, but less than the power sufficient to activate the drive circuit.

The discharge circuit is preferably adapted to drain power either from the mains input of the power adaptor, eg at the mains input of an input rectifier, or from DC link capacitors that link the input rectifier with the drive circuit. Most preferably, however, the discharge circuit is adapted to drain power from the mains input of an input rectifier. In particular, the DC link capacitors are preferably not discharged by the discharge circuit, such that the power stored by the DC link capacitors is available for driving the LEDs.

The discharge circuit preferably provides a current path between live and neutral, in order to discharge power. The discharge circuit preferably comprises a resistive load, such as a single resistor, and a first electronic switch, eg a FET, activation of which activates the resistive load and hence the discharge circuit. The first electronic switch is preferably controlled by a connection to the auxiliary power supply, and a connection to the drive circuit. In particular, the discharge circuit preferably includes a second electronic switch that deactivates the first electronic switch, and hence the discharge circuit, if the drive circuit is activated or the output of the auxiliary power supply falls below a deactivation level. The first and second electronic switches are preferably FETs.

The power adaptor according to the invention may be connected to an AC power supply including an electrical dimmer. Conventional electrical dimmers include a TRIAC, which is generally bypassed by a capacitor and has an inductor in series with its output. Even when such electrical dimmers are switched off, they typically provide a small current to the power adaptor. In this arrangement, the discharge circuit of the power adaptor according to the invention will preferably be activated when the output of the auxiliary power supply reaches an activation level. As discussed above, this activation level is preferably greater than zero, but less than the output sufficient to activate the drive circuit.

Once activated, the discharge circuit will preferably remain active until the output of the auxiliary power supply has decreased below the deactivation level. The discharge circuit will therefore intermittently drain power, such that the drive circuit is not activated when the electrical dimmer is switched off. The discharge circuit therefore prevents the intermittent flickering that would otherwise occur when the electrical dimmer is switched off.

When the power adaptor is connected to a mains power supply without an electrical dimmer, or alternatively the electrical dimmer of the mains power supply is at full power, the discharge circuit will remain turned off, such that no power is drained. In particular, as discussed above, the discharge circuit is only active when the drive circuit is inactive. Furthermore, the electronic switch(es) of the discharge circuit are preferably connected to the auxiliary power supply, such that the electronic switch(es) of the discharge circuit are not directly connected to the input of the power adapter, which is typically at high voltage, and hence there are no significant losses through such connections. Hence, at full power, the discharge circuit does not cause significant power losses, and hence maintains the power adaptor at its optimum efficiency.

Since the discharge circuit is preferably not active when the drive circuit is active, the drive circuit is active and the discharge circuit is not active when the mains input reaches a significant proportion of full mains voltage during normal operation. However, in order to reduce the risk of damage to the discharge circuit, the power adaptor may also include a connection between the input of the power adaptor and the discharge circuit, which deactivates the discharge circuit in the event that the mains input reaches a pre-determined level during use, such as a pre-determined proportion of full mains voltage, eg 30%.

Although this connection would act to deactivate the discharge circuit when the mains input reaches a particular level, this connection is different to prior art arrangements that rely on a connection along these lines to deactivate the discharge circuit during normal operation. In particular, these prior art arrangements must deactivate the discharge circuit at a much lower low level, eg 3% of full mains voltage, than the connection of the present invention, which deactivates the discharge circuit when the drive circuit is active. The present invention is therefore compatible with a greater range of dimmers than prior art arrangements.

As discussed above, the discharge circuit is adapted to be active during at least a portion of the period in which the drive circuit is inactive in each mains cycle, and the discharge circuit is adapted to be inactive during at least a portion of the period in which the drive circuit is active in each mains cycle. Furthermore, in presently preferred embodiments, the discharge circuit is adapted to drain power only when the drive circuit is inactive in each mains cycle. The power adaptor is therefore suitable for use with an electrical dimmer that provides a mains supply including at least one ON-period and at least one OFF-period in each mains cycle, ie a chopped waveform, when the electrical dimmer is switched on, but is providing less than full power to the power adaptor.

The power adaptor is preferably adapted such that when the power adaptor receives a chopped waveform from an electrical dimmer, the auxiliary power supply provides a voltage to the drive circuit that rises during at least an initial portion of the ON-period of the mains cycle, and the auxiliary power supply discharges during a final portion of the ON-period of the mains cycle or during the OFF-period of the mains cycle. Furthermore, the auxiliary power supply is preferably adapted to discharge sufficiently quickly during the OFF-period of the mains cycle for the drive circuit to be deactivated, but sufficiently slowly for the discharge circuit to remain active throughout the OFF-period of the mains cycle. The power adaptor preferably therefore includes an energy storage device, such as a capacitor, to provide power that reduces the decay in the output of the auxiliary power supply.

The discharge circuit may be adapted to provide a substantially instantaneous load when the electrical dimmer switches from an OFF-period to an ON-period. However, in presently preferred embodiments, the power adaptor includes a snubber circuit, which acts to provide a substantially instantaneous load when the electrical dimmer switches from an OFF-period to an ON-period. In particular, the snubber circuit preferably drains each cycle, such that an instantaneous load is provided. In these embodiments, both the discharge circuit and the snubber circuit provide a load to the external dimmer circuit during normal use. These features enable the power adaptor to be used with high speed dimmer circuits, such as push button dimmers or digital dimmers. The power generated by the snubber circuit is preferably provided to the drive circuit, and hence the snubber circuit preferably acts as the auxiliary power supply.

The drive circuit preferably includes a control circuit, which is preferably an integrated circuit. In these embodiments, the auxiliary power supply preferably provides power to the control circuit, and the discharge circuit is preferably connected to the control circuit. The control circuit preferably activates the drive circuit when the power supply from the auxiliary power supply exceeds an activation level, and the discharge circuit is preferably adapted to be deactivated by the control circuit when the drive circuit is active.

The period over which the discharge circuit is not active may be controlled by the drive circuit, for example when the drive circuit is deactivated, the discharge circuit is activated. However, a timing circuit may instead be provided to control the period over which the discharge circuit is not active, in order to prevent variations in the power consumption of the drive circuit to affect the timing of the discharge circuit.

The drive and control circuits may be formed at least in part by an integrated circuit. In this arrangement, the power adaptor preferably includes an averaging filter that smooths the on/off transition of the integrated circuit. This reduces the flicker when the power adaptor is used with dimmers that provide very low power, ie the ON portions of the mains cycle are very short.

In preferred embodiments, the power adaptor is adapted to provide power to the drive circuit when the discharge circuit is active, such that the drive circuit is not activated, but is able to turn on quicker, particularly at low power levels. This power supply may be controlled by an electronic switch that activates when the discharge circuit is activated.

The power adaptor may be adapted such that when the power adaptor receives a chopped waveform from an electrical dimmer, the drive circuit is adapted to be disabled by the control circuit when the ON-period of the mains cycle is shorter than a pre-determined period. In addition, however, the control circuit may include a delay that extends the period of disablement of the drive circuit beyond the ON-period of the mains cycle.

The drive circuit may be any circuit suitable for driving a solid state light source. However, in presently preferred embodiments, the drive circuit includes an LCL series-parallel resonant circuit, in an arrangement along the lines of that disclosed in WO 2008/120019 A1. By “LCL series-parallel resonant circuit” is meant a resonant circuit comprising a first inductor and a first capacitor in series, and a parallel load including a second inductor. The resonant circuit preferably comprises a load connected in parallel across the first capacitor, wherein the load comprises the second inductor and an output for driving the solid state light source, which are connected in series. Any of the first inductor, the first capacitor and the second inductor may comprise a single inductive or capacitive component or a combination of such components. In these embodiments, the control circuit preferably includes an oscillator and one or more electronic switches, which together provide a signal suitable for driving the resonant circuit.

In these embodiments, the discharge circuit is preferably adapted to drain power either from the mains input of an input rectifier or from DC link capacitors that link the input rectifier with the resonant circuit.

The drive circuit is preferably adapted to provide, at a given input voltage, a constant current output. The power delivered to the output of the power adaptor preferably therefore varies with variation of the voltage at the input, with no need for any control. In particular, the magnitude of the constant current is preferably proportional to the input voltage. Furthermore, the drive circuit is preferably adapted to provide, at a given input voltage, a constant current output that is independent of the load.

The solid state light source is preferably a Light Emitting Diode (LED), or a series of two or more LEDs. Where a user has access to the solid state light source that is driven by the power adaptor, the power adaptor preferably includes either a transformer or a capacitor at the output of the resonant circuit. In addition, the power adaptor preferably includes one or more diodes at its output, eg a diode bridge, to ensure that no reverse currents are present that could damage the light source.

The power adaptor may include a filter at its input for reducing harmonic currents drawn from the mains supply. The filter may comprise a small non-electrolytic capacitor-inductor network. The power adaptor preferably also includes a rectifier at its input that converts the input waveform to one of constant polarity. Most preferably, the rectifier is a full wave rectifier that reverses the negative (or positive) portions of the alternating current waveform.

According to a further aspect of the invention, there is provided a lighting system comprising a power adaptor as described above and a lighting unit including at least one solid state light source.

The lighting unit will typically be provided with a plurality of solid state light sources. In order to achieve different colours of light output, the lighting unit may include solid state light sources that emit light of different colours, for example LEDs that emit light of red, green and blue colour. Furthermore, the lighting unit may also include LEDs of amber, cyan and white colour in order to raise the colour rendering index.

The power adaptor and the lighting unit may have a common housing, or may be housed separately. Indeed, the power adaptor may be adapted to provide power to a plurality of lighting units, each lighting unit including a plurality of solid state light sources. Furthermore, the lighting system may include a plurality of such power adaptors. The lighting system may also include an electrical dimmer that provides a mains supply including at least one ON-period and at least one OFF-period in each mains cycle, ie a chopped waveform, when the electrical dimmer is switched on, but is providing less than full power to the power adaptor.

Where the power adaptor is adapted so that the light output from the solid state light source is only controllable by varying the power available at the input of the power adaptor, the power adaptor is particularly suitable for use with a lighting unit including an integral power adaptor, which would be suitable for incorporation into a conventional lighting circuit.

Hence, according to a further aspect of the invention, there is provided a lighting unit suitable for direct connection to a mains supply, the lighting unit comprising a power adaptor as described above and one or more solid state light sources, in which the light output from the one or more solid state light sources is only controllable by varying the power available at the input of the power adaptor. In order to maximise the efficiency of the power adaptor, the power adaptor is preferably adapted to transfer all power available at the input, save for unavoidable losses, to the output of the power adaptor.

The lighting unit preferably comprises a housing for accommodating the power adaptor and the one or more solid state light sources, and a connector for connecting the input of the power adaptor to the mains supply. The connector is preferably adapted to connect to a fitting for a conventional filament light bulb. In particular, the lighting unit may include a bayonet or threaded connector.

A preferred embodiment of the invention will now be described in greater detail, by way of illustration only, with reference to the accompanying drawings, in which

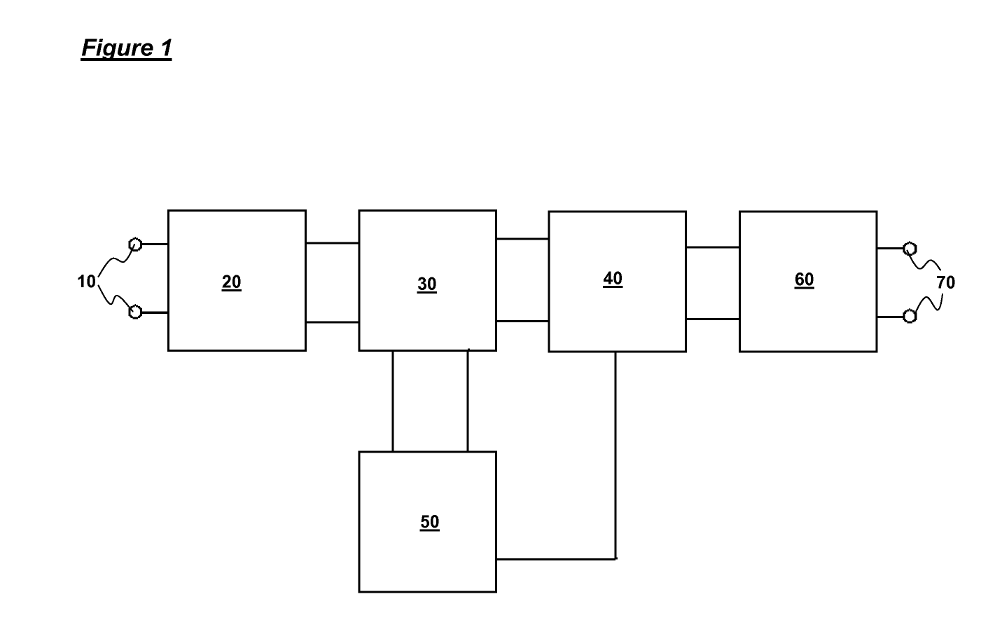

FIG. 1 is a schematic diagram of a first embodiment of a power adaptor according to the invention;

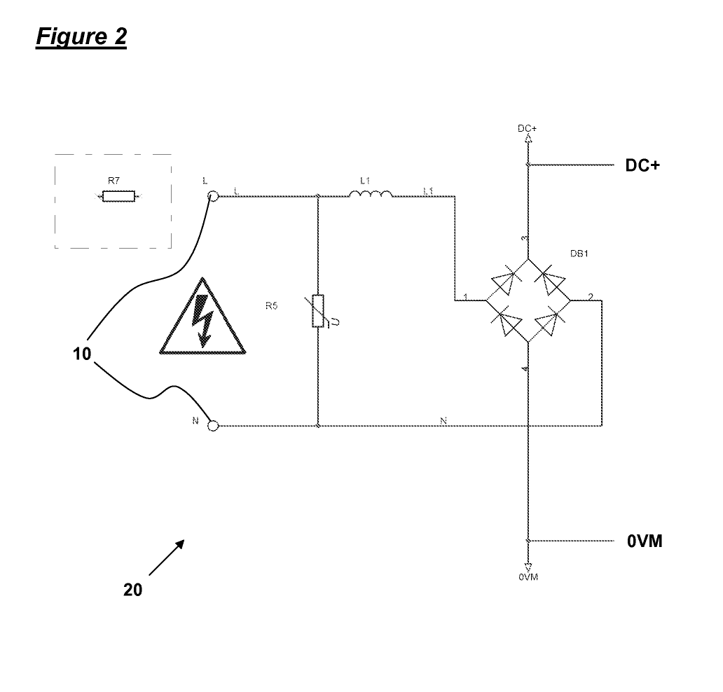

FIG. 2 is a circuit diagram of an input rectifier of the first embodiment;

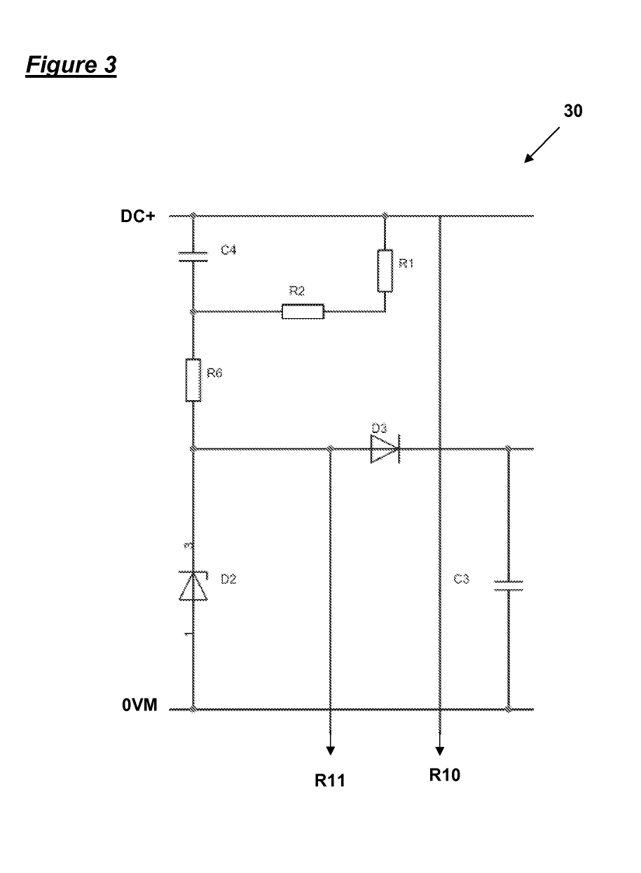

FIG. 3 is a circuit diagram of a combined snubber and auxiliary supply of the first embodiment;

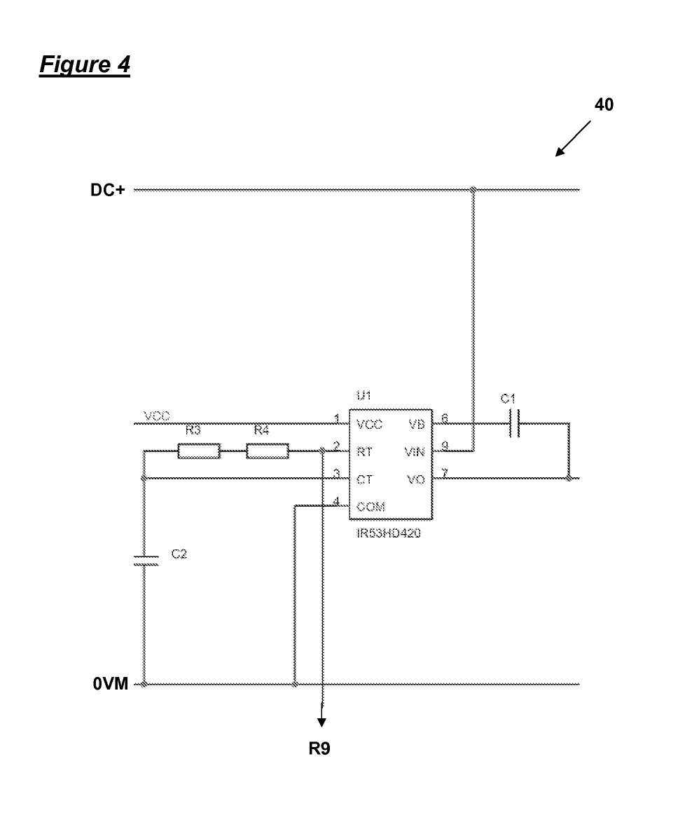

FIG. 4 is a circuit diagram of a control circuit of the first embodiment;

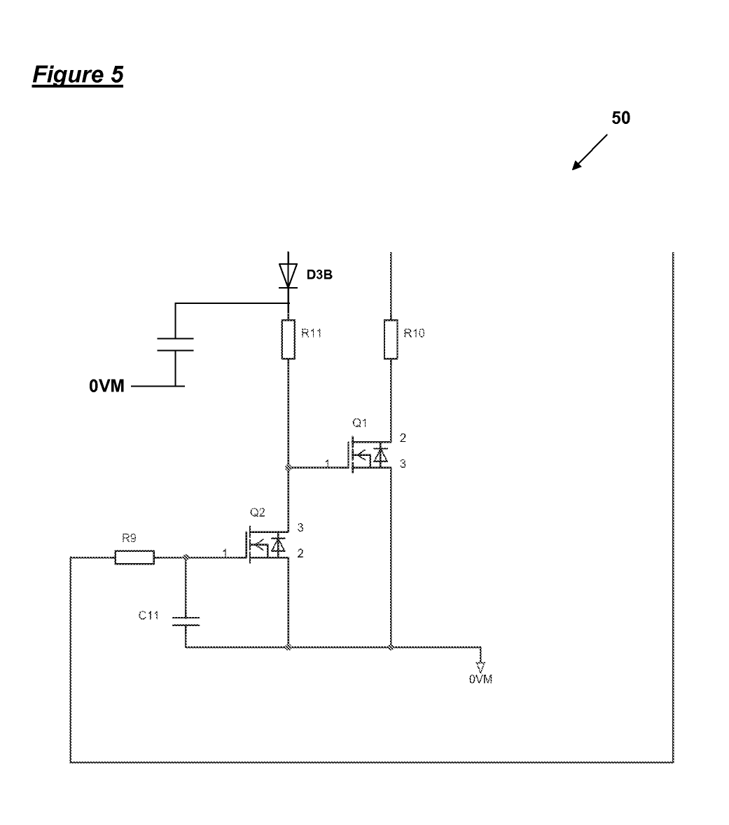

FIG. 5 a circuit diagram of a discharge circuit of the first embodiment;

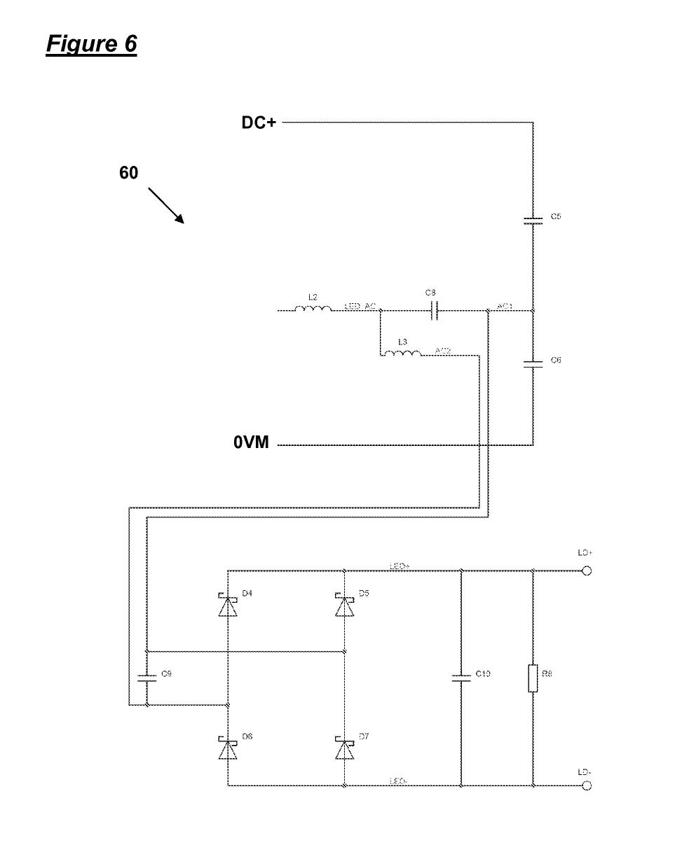

FIG. 6 is a circuit diagram of a drive circuit of the first embodiment;

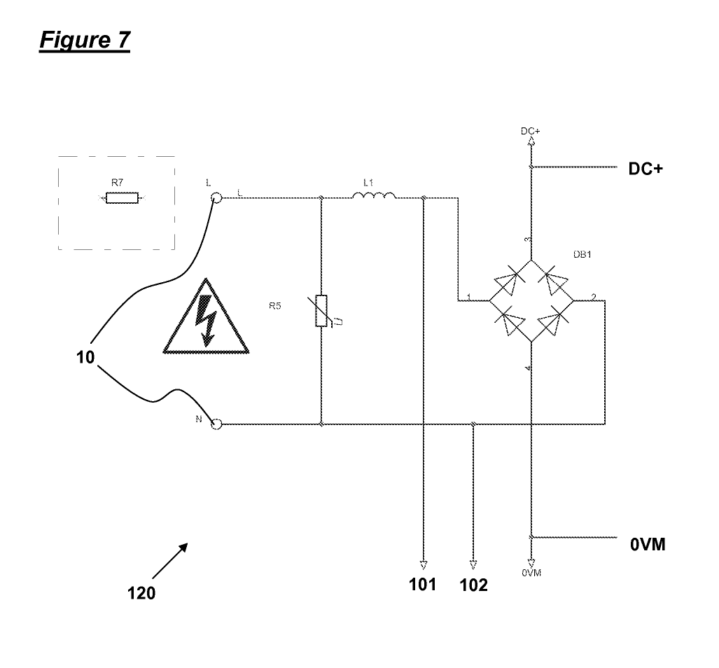

FIG. 7 is a circuit diagram of an input rectifier of a second embodiment of a power adaptor according to the invention;

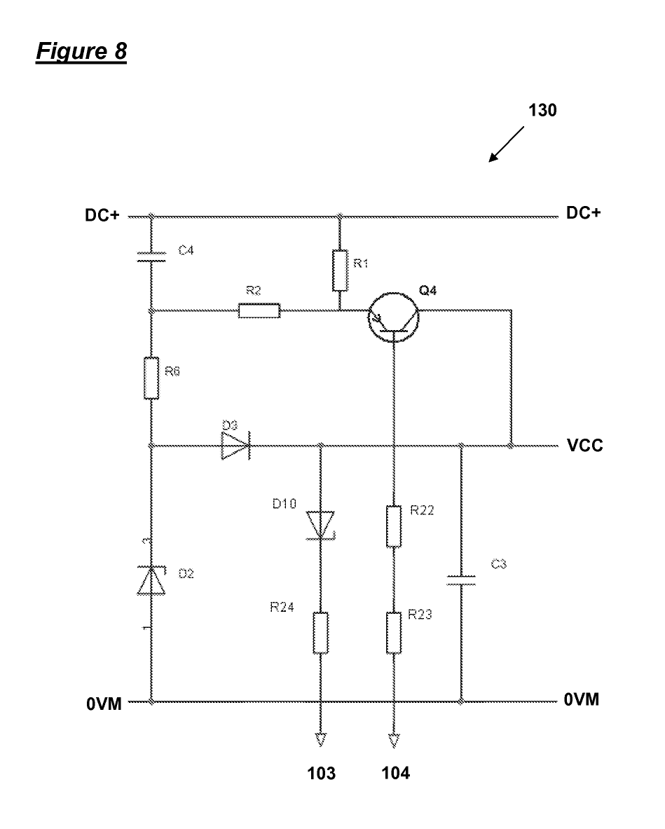

FIG. 8 is a circuit diagram of a combined snubber and auxiliary supply of the second embodiment;

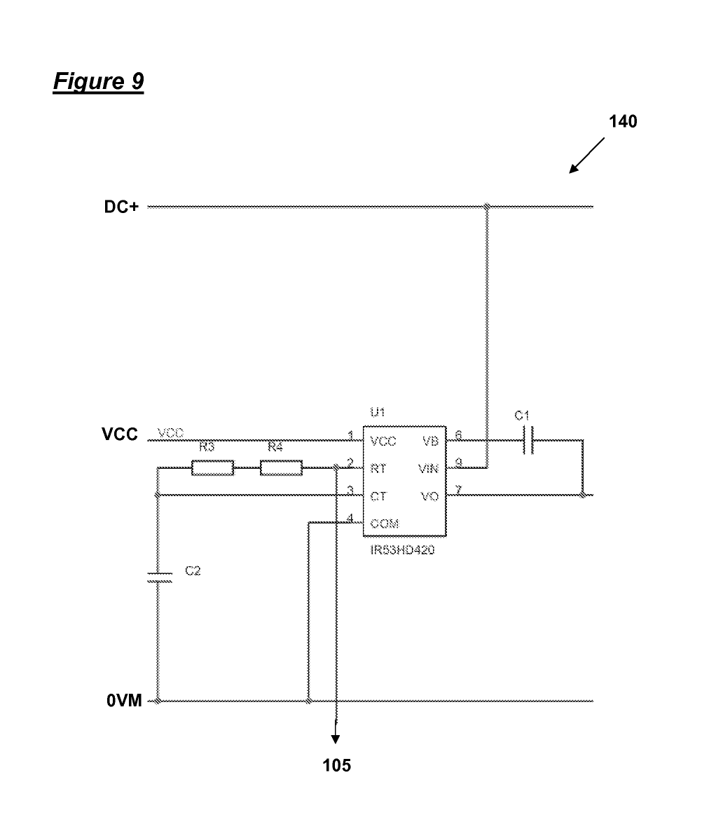

FIG. 9 is a circuit diagram of a control circuit of the second embodiment;

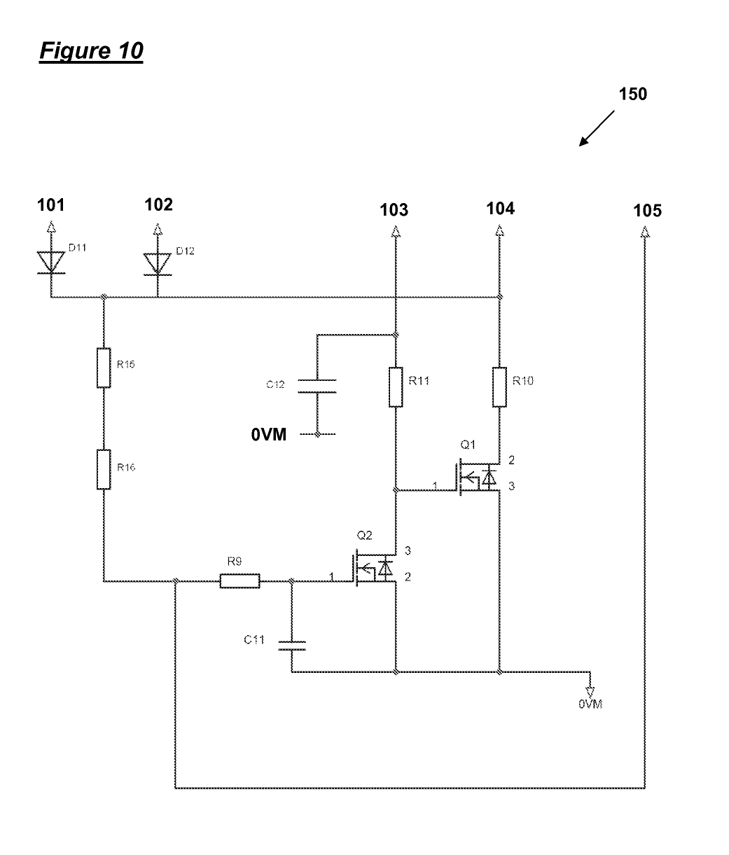

FIG. 10 a circuit diagram of a discharge circuit of the second embodiment; and

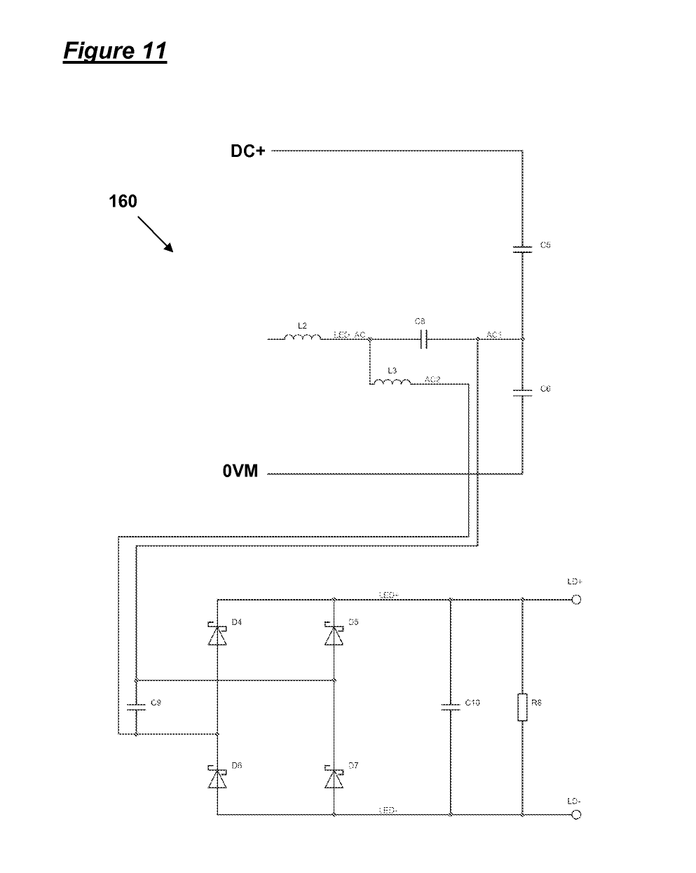

FIG. 11 is a circuit diagram of a drive circuit of the second embodiment.

FIG. 1 is a schematic diagram of a power adaptor according to the invention. The power adaptor comprises an AC mains input 10, an input rectifier 20, a combined snubber and auxiliary supply 30, a control circuit 40, a discharge circuit 50, a drive circuit 60, and an output 70.

The AC mains input 10 is adapted for connection to an AC mains supply, with or without an electrical dimmer, that forms part of a lighting system. In conventional lighting systems, the electrical dimmer will typically include a TRIAC, which is bypassed by a capacitor and has an inductor in series with its output. The output 70 of the power adaptor is adapted for connection to a solid state light source, eg an LED or a string of LEDs in series.

The input rectifier 20 (see FIG. 2) includes an input inductor L1 and a bridge rectifier DB1 for providing DC power (DC+, 0VM) to the power adaptor. The combined snubber and auxiliary supply 30 (see FIG. 3) is primarily a snubber circuit for preventing variation of the current, ie “ringing”, that would otherwise be caused by the input inductor L1 feeding the drive circuit 60. In particular, this ensures that a sufficiently continuous current is drawn from the AC mains supply to keep the TRIAC of the electrical dimmer turned on. In addition, the combined snubber and auxiliary supply 20 is adapted to supply low voltage DC power (VCC) to the Programmable Integrated Circuit U1 (the “PIC” U1) of the control circuit 40.

The control circuit 40 (see FIG. 4) is adapted to control the drive circuit 60 of the power adaptor, such that the output of the drive circuit 60 is suitable for driving an LED. In particular, in this embodiment, the drive circuit 60 (see FIG. 6) includes an LCL series-parallel resonant circuit, as disclosed in WO 2008/120019 A1. The PIC U1 of the control circuit 50 therefore includes electronic switches, such as two FETs, that provide an oscillating signal (eg a square wave driving signal) to the drive circuit 60, at the desired frequency to drive the LCL series-parallel resonant circuit.

The discharge circuit 50 (see FIG. 5) is adapted to ensure that the control and drive circuits 40,60 remain inactive, and hence no power is provided to the output 70, when the electrical dimmer is switched off, but nevertheless supplies a small current to the power adaptor. This is a particular problem with conventional electrical dimmers that include TRIACs.

The discharge circuit includes a load resistor R10 and a FET Q1 connected in series to the DC output (DC+, 0VM) of the input rectifier 20. The gate voltage of FET Q1 is provided by a resistor R11 and FET Q2 connected in series to the low voltage output (VCC) of the combined snubber and auxiliary supply 30. FET Q1 is therefore turned on when the voltage output (VCC) of the combined snubber and auxiliary supply 30 is sufficient. Furthermore, the gate voltage of FET Q2 is provided by a connection to the PIC U1 of the control circuit 40, such that FETs Q1 and Q2 are turned off when the oscillator of the PIC U1 is running.

The power adaptor is configured such that the load resistor R10 is energised when the voltage output (VCC) of the combined snubber and auxiliary supply 30 is sufficient, via R11, to turn on FET Q1, but the load resistor R10 is de-energised when the voltage output (VCC) supplied to the PIC U1 is sufficient for the oscillator to run. The voltage sufficient to turn on FET Q1 is less than the voltage sufficient for the oscillator to run.

Hence, when the electrical dimmer is switched off, but nevertheless supplies a small current to the power adaptor, the load resistor R10 will become energised when the voltage output (VCC) of the combined snubber and auxiliary supply 30 reaches a level sufficient for FET Q1 to be turned on. However, this voltage level will be less than the level required for the oscillator of the PIC U1 to run. Once energised, the load resistor R10 will remain energised until the voltage output (VCC) of the combined snubber and auxiliary supply 30 has decreased below the gate voltage of Q2. The discharge circuit 50 will therefore intermittently discharge power, and in particular will drain power from the mains input to the input rectifier 20 or the DC link capacitors (C5,C6) of the drive circuit 60, such that the control and drive circuits 40,60 are not activated when the electrical dimmer is switched off. The discharge circuit therefore prevents the intermittent flickering that would otherwise occur when the electrical dimmer is switched off.

When the power adaptor is connected to an AC mains supply without an electrical dimmer, or alternatively the electrical dimmer of the AC mains supply is at full power, FET Q1 will remain turned off, such that no power is discharged through the load resistor R10. In particular, as discussed above, FET Q1 only turns on when the oscillator in the PIC U1 stops running. Furthermore, the gate voltages of the FETs Q1,Q2 are not provided by connections to the DC output (DC+, 0VM) of the input rectifier 20, which would cause power to be lost through the resistors of such connections. Hence, at full power, the discharge circuit does not cause significant power losses, and hence maintains the power adaptor at its optimum efficiency.

When the power adaptor receives a chopped waveform from the electrical dimmer, and hence the electrical dimmer is switched on, but is providing less than 100% power to the power adaptor, the load resistor R10 will generally be energised during the OFF potion of the mains cycle, and will generally be de-energised during the ON portion of the mains cycle. This is achieved by providing a voltage output (VCC) of the combined snubber and auxiliary supply 30 that decays sufficiently quickly during the OFF potion of the mains cycle for the oscillator of the PIC U1 to stop running, but sufficiently slowly for the load resistor R10 to remain energised throughout the OFF potion of the mains cycle.

In particular, in the ON portion of the mains cycle, FET Q1 will remain turned off because the oscillator in the PIC U1 is running. When the mains cycle enters its OFF portion, the oscillator in the PIC U1 stops running, causing FET Q1 to be turned on. As discussed above, FET Q1 is adapted to stay turned on until the voltage output (VCC) of the combined snubber and auxiliary supply 30 decreases below the gate voltage of Q2. However, this decrease in the voltage output (VCC) is adapted to take longer than the 10 ms mains half-cycle by the capacitor C12. FET Q1 will therefore remain turned on during the OFF potion of the mains cycle, until the voltage rises again.

During the voltage rise in the ON portion of each mains cycle, there will be a short time period during which FET Q1 will be turned on, due to the voltage output (VCC) being sufficient to provide the gate voltage, but insufficient to drive the oscillator of the PIC U1. However, this time period will be very short because the voltage will soon rise to the level sufficient to drive the oscillator of the PIC U1, such that FET Q1 is turned off. Indeed, the faster the voltage rise and the greater the final voltage supplied by the AC mains supply, the shorter this time period.

Unlike conventional discharge circuits, there is no detection of the input voltage of the power adaptor to turn on the load resistor R10 and then shut off the control and drive circuits 40,60. Instead, the power adaptor according to the invention includes a discharge circuit 50 that acts to drain the low voltage auxiliary supply of the power adaptor, and the discharge circuit 50 is deactivated by detection of the on state of the control and drive circuits 40,60.

FIGS. 7 to 11 are circuit diagrams of a second embodiment of a power adaptor according to the invention. In particular, FIG. 7 shows the input rectifier 120, FIG. 8 shows the combined snubber and auxiliary supply 130, FIG. 9 shows the control circuit 140, FIG. 10 shows the discharge circuit 150, and FIG. 11 shows the drive circuit 160. The circuits of the second embodiment 120,130,140,150,160 are similar to the circuits of the first embodiment 20,30,40,50,60, but differ in a number of aspects. These differences are discussed in more detail below.

In the second embodiment, the load resistor R10 of the discharge circuit 150 is connected to the input side of the bridge rectifier DB1, via diodes D11 and D12, such that power is drawn from the mains input of the input rectifier 120, rather than from the DC link capacitors C5,C6 of the drive circuit 60, when the discharge circuit 150 is active. This is advantageous because the DC link capacitors C5,C6 are not discharged by the discharge circuit 150, and hence the power stored by the DC link capacitors C5,C6 is available for driving the LEDs. This arrangement may therefore provide a more efficient power adaptor.

As in the first embodiment, the gate voltage of FET Q2 is provided by a connection to the PIC U1 of the control circuit 40, such that FETs Q1 and Q2 are turned off when PIC U1 is running. Hence, during normal operation, the load resistor R10 is deactivated before the mains input reaches a level that could damage the components of the discharge circuit 150. However, a connection is also provided between the mains input of the input rectifier 120 and the gate of FET Q2. This connection acts to turn on FET Q2, and hence turn off FET Q1 and deactivate the load R10, when the mains input reaches around 30% of full mains voltage. This connection would therefore deactivate the discharge circuit 150 in the event that the power adaptor is connected to a main supply of incorrect voltage, or the PIC U1 is malfunctioning and does not start, for example, in order to prevent damage to the components of the discharge circuit 150.

Although this connection acts to deactivate the discharge circuit 150 when the mains input reaches a particular level, this connection is different to prior art arrangements that rely on a connection along these lines to deactivate the discharge circuit during normal operation. In particular, these prior art arrangements must deactivate the discharge circuit at a much lower low level, eg 3% of full mains voltage, than the connection of the present invention, which deactivates the discharge circuit 150 when PIC U1 is running. The present invention is therefore compatible with a greater range of dimmers than prior art arrangements.

As in the first embodiment, when the power adaptor receives a chopped waveform from the electrical dimmer, and hence the electrical dimmer is switched on, but is providing less than 100% power to the power adaptor, the load resistor R10 will generally be energised during the OFF potion of the mains cycle, and will generally be de-energised during the ON portion of the mains cycle. In particular, when the mains cycle enters its OFF portion, the oscillator in the PIC U1 stops running, causing FET Q1 to be turned on. FET Q1 is adapted to stay turned on until the voltage output (VCC) of the combined snubber and auxiliary supply 30 decreases below the gate voltage of Q2. However, this decrease in the voltage output (VCC) is adapted to take longer than the 10 ms mains half-cycle by the capacitor C12. FET Q1 will therefore remain turned on during the OFF potion of the mains cycle, until the voltage rises again.

In this regard, the second embodiment includes a zener diode D10 and a resistor R24 in the connection between C12 and VCC, which act as an averaging filter that smooths the on/off transition of PIC U1 of the control circuit 40. This reduces the flicker when the power adaptor is used with dimmers that provide very low power, ie the ON portions of the mains cycle are very short.

In addition, a transistor, Q4, has been added to the combined snubber and auxiliary supply 30, which is arranged to increase the current supplied to the PIC U1 of the control circuit 40 when the PIC U1 is not running, and hence R10 is active. This additional current enables the PIC U1 to be turned on quicker from its standby mode, particularly at low dimmer levels or phase angles.

Finally, it has been recognised that the power consumption of PIC U1 may vary significantly between devices, and this may affect the timing of the switching of the discharge circuit 150. In particular, when either the first or second embodiment is receiving a chopped waveform, the oscillator of PIC U1 will run, each mains cycle, until capacitor C3 has discharged. The time at which PIC U1 stops running will therefore depend upon the power consumption of PIC U1.

A further embodiment of the power adaptor according to the invention therefore includes a constant-current timing circuit that controls FET Q2, in place of the link to PIC U1 of the first and second embodiments. This enables more accurate control of the periods in which the discharge circuit 150 is deactivated.

1. A power adaptor for a solid state light source, the power adaptor comprising an input for connection to a mains power supply, a drive circuit for providing an output suitable for driving the solid state light source, and a discharge circuit adapted to drain power by providing a discharge current path, wherein the discharge circuit is adapted to be active during at least a portion of the period in which the drive circuit is inactive, and the discharge circuit is adapted to be inactive during at least a portion of the period in which the drive circuit is active.

2. A power adaptor as claimed in claim 1, wherein the discharge circuit is adapted to be active during at least a portion of the period in which the drive circuit is inactive in each mains cycle, and the discharge circuit is adapted to be inactive during at least a portion of the period in which the drive circuit is active in each mains cycle.

3. A power adaptor as claimed in claim 1, wherein the discharge circuit is adapted to drain power only when the drive circuit is inactive in each mains cycle.

4. A power adaptor as claimed in claim 1, wherein the power adaptor includes an auxiliary power supply that provides reduced voltage power to the drive circuit.

5. A power adaptor as claimed in claim 4, wherein the discharge circuit is adapted to drain power when the output of the auxiliary power supply is greater than a pre-determined level.

6. A power adaptor as claimed in claim 5, wherein the pre-determined level is less than the level at which the drive circuit is activated.

7. A power adaptor as claimed in claim 4, wherein the discharge circuit is adapted to drain power when the output of the auxiliary power supply is greater than an activation level that is greater than zero, but less than the power sufficient to activate the drive circuit.

8. A power adaptor as claimed in claim 1, wherein the discharge circuit is adapted to drain power from the input of the power adaptor.

9. A power adaptor as claimed in claim 8, wherein the discharge circuit is adapted to drain power from the mains input side of an input rectifier.

10. A power adaptor as claimed in claim 1, wherein the discharge circuit provides a current path between live and neutral, in order to discharge power.

11. A power adaptor as claimed in claim 10, wherein the discharge circuit comprises a resistive load, and a first electronic switch, activation of which activates the resistive load and hence the discharge circuit.

12. A power adaptor as claimed in claim 11, wherein the first electronic switch is controlled by a connection to the auxiliary power supply, and a connection to the drive circuit.

13. A power adaptor as claimed in claim 11, wherein the discharge circuit includes a second electronic switch that deactivates the first electronic switch, and hence the discharge circuit, if the drive circuit is activated or the output of the auxiliary power supply falls below a deactivation level.

14. A power adaptor as claimed in claim 1, wherein the power adaptor is adapted such that when connected to an AC power supply including an electrical dimmer, and the electrical dimmer provides a small current to the power adaptor when switched off, the discharge circuit of the power adaptor is activated when the output of the auxiliary power supply reaches an activation level.

15. A power adaptor as claimed in claim 14, wherein the discharge circuit is adapted to remain active until the output of the auxiliary power supply has decreased below the deactivation level.

16. A power adaptor as claimed in claim 1, wherein the power adaptor is adapted such that when the power adaptor is connected to a mains power supply without an electrical dimmer, or alternatively the electrical dimmer of the mains power supply is at full power, the discharge circuit will remain turned off, such that no power is drained.

17. A power adaptor as claimed in claim 1, wherein the power adaptor includes a connection between the input of the power adaptor and the discharge circuit, which deactivates the discharge circuit in the event that the mains input power reaches a pre-determined level during use.

18. A power adaptor as claimed in claim 1, wherein the power adaptor includes an auxiliary power supply that provides reduced voltage power to the drive circuit, and the discharge circuit is adapted to drain power when the output of the auxiliary power supply is greater than a pre-determined level that is less than the level at which the drive circuit is activated.

19. A power adaptor as claimed in claim 18, wherein the power adaptor is adapted such that when the power adaptor receives a chopped waveform from an electrical dimmer, the auxiliary power supply provides a voltage to the drive circuit that rises during at least an initial portion of the ON-period of the mains cycle, and the auxiliary power supply discharges during a final portion of the ON-period of the mains cycle or during the OFF-period of the mains cycle.

20. A power adaptor as claimed in claim 19, wherein the auxiliary power supply is adapted to discharge sufficiently quickly during the OFF-period of the mains cycle for the drive circuit to be deactivated, but sufficiently slowly for the discharge circuit to remain active throughout the OFF-period of the mains cycle.

21. A power adaptor as claimed in claim 20, wherein the power adaptor includes an energy storage device to provide power that reduces the decay in the output of the auxiliary power supply.

22. A power adaptor as claimed in claim 19, wherein the auxiliary power supply also acts as a snubber circuit, thereby providing a substantially instantaneous load when the electrical dimmer switches from an OFF-period to an ON-period.

23. A power adaptor as claimed in claim 19, wherein the discharge circuit is adapted to provide a substantially instantaneous load when the electrical dimmer switches from an OFF-period to an ON-period.

24. A power adaptor as claimed in claim 1, wherein the drive circuit includes a control circuit, the auxiliary power supply provides power to the control circuit, and the discharge circuit is connected to the control circuit.

25. A power adaptor as claimed in claim 24, wherein the control circuit activates the drive circuit when the power supply from the auxiliary power supply exceeds an activation level, and the discharge circuit is adapted to be deactivated by the control circuit when the drive circuit is active.

26. A power adaptor as claimed in claim 1, wherein the period over which the discharge circuit is not active is controlled by the drive circuit, such that when the drive circuit is deactivated, the discharge circuit is activated.

27. A power adaptor as claimed in claim 1, wherein a timing circuit is provided to control the period over which the discharge circuit is not active.

28. A power adaptor as claimed in claim 1, wherein the drive circuit includes a control circuit, and the drive and control circuits are formed at least in part by an integrated circuit.

29. A power adaptor as claimed in claim 28, wherein the power adaptor includes an averaging filter that smooths the on/off transition of the integrated circuit.

30. A power adaptor as claimed in claim 1, wherein the power adaptor is adapted to provide power to the drive circuit when the discharge circuit is active, such that the drive circuit is not activated, but the speed of start-up of the drive circuit is increased.

31. A power adaptor as claimed in claim 30, wherein the power supply to the drive circuit, when the discharge circuit is active, is controlled by an electronic switch that activates when the discharge circuit is activated.

32. A power adaptor as claimed in claim 1, wherein the power adaptor is adapted such that when the power adaptor receives a chopped waveform from an electrical dimmer, the drive circuit is adapted to be disabled by a control circuit when the ON-period of the mains cycle is shorter than a pre-determined period.

33. A power adaptor as claimed in claim 32, wherein the control circuit includes a delay that extends the period of disablement of the drive circuit beyond the ON-period of the mains cycle.

34. A power adaptor as claimed in claim 1, wherein the drive circuit includes an LCL series-parallel resonant circuit.

35. A power adaptor as claimed in claim 34, wherein the control circuit includes an oscillator and one or more electronic switches, which together provide a signal suitable for driving the resonant circuit.

36. A power adaptor as claimed in claim 35, wherein the discharge circuit is adapted to drain power either from the mains input of an input rectifier or from DC link capacitors that link the input rectifier with the resonant circuit.

37. A lighting system comprising a power adaptor as claimed in any preceding claim and a lighting unit including a solid state light source.

38. A lighting system as claimed in claim 37, wherein the lighting unit is provided with a plurality of solid state light sources.

39. A lighting unit suitable for direct connection to a mains supply, the lighting unit comprising a power adaptor as claimed in any preceding claim and a solid state light source.

40. A lighting unit as claimed in claim 39, wherein the lighting unit comprises a housing for accommodating the power adaptor and the solid state light source, and a connector for connecting the input of the power adaptor to the mains supply.
